(19) United States
(12) Patent Application Publication
(10) Pub. No.: US 2007/0112979 A1
(43) Pub. Date: May 17, 2007

(54) [PORTABLE STORAGE DEVICE WITH AUTO-EXECUTABLE PROGRAM]

(75) Inventor: Yi-Hung Peng, TAIPEI (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: PHISON ELECTRONICS CORP., Chutung Town, Hsinchu Hsien (TW)

(21) Appl. No.: 11/164,249

(22) Filed: Nov. 16, 2005

(51) Int. Cl. G06F 3/00

(52) U.S. Cl. 710/8

(57) ABSTRACT

A portable storage device with auto-executable program is provided. The portable storage device comprises a microcontroller, a transmission interface, a triggering device and a memory. The triggering device is connected to the microcontroller and the memory is electrically connected to the microcontroller. After connecting the portable storage device to a host end, the host end automatically runs a control program of the memory and installs the control program in the host end. While the control program senses signals generated by the triggering device, the control program will execute an application program of the host end according to a type of signal.

### BACKGROUND OF INVENTION

1. Field of the Invention

The present invention generally relates to a portable storage device, and more particularly to a portable storage device with auto-executable program, wherein when the portable storage device is connected to the host end, the control program is automatically executed and installed in the host end enabling the host end to execute the application programs, renew or open documents through operating the triggering device.

2. Description of Related Art

With the improved flash memory technology, demand for larger capacity of the memory card and the portable storage device is increasing ever since. Especially, the portable storage device has become an indispensable tool for the users in every aspect of life. The advantageous features of the portable storage device, such as small size, large capacity and fast transmission speed, have made the portable storage device as a very popular tool for transferring or backing-up files.

However, the above portable storage device only facilitates storage of data regardless of brand and type. The user has to operate the portable storage device in the usage status, which makes the portable storage device as a passive tool.

Generally speaking, when the user is using the portable storage device, the user has to be aware of some particular files or programs that have to be transferred or executed. If the user omits the file, which is needed to have a backup or to be handled, the portable storage device must be connected to the host end frequently until the job is completed.

Therefore, how to overcome the above defects of the conventional art is an important issue for the manufacturers in the field.

### SUMMARY OF THE INVENTION

According to an aspect of the present invention, when the portable device is connected to the host end, the control program is automatically executed and installed in the host end. Simultaneously, the control program senses signals generated by operating the triggering device and control the host end for executing the application program according to the type of the signals.

### BRIEF DESCRIPTION OF THE DRAWING

FIG. 1 is a block diagram of a portable storage device according to an embodiment of the present invention.

FIG. 2 is a flowchart of setting a control program according to an embodiment of the present invention.

FIG. 3 is a flowchart of an operation procedure according to an embodiment of the present invention.

FIG. 4 is a flowchart of retrieving an image according to an embodiment of the present invention.

### DETAIL DESCRIPTION OF THE INVENTION

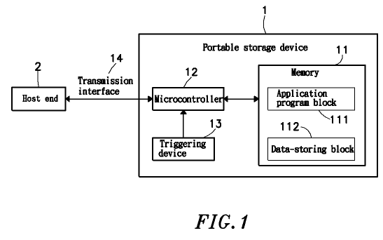

Referring to FIG. 1, a portable storage device 1 of the present invention comprises a memory 11, a microcontroller 12, a triggering device 13 and a transmission interface 14.

The memory 11 comprises at least an application program block 111 and a data-storing block 112. The application program block 111 comprises a control program in an ISO9660 format, enabling the application program block 111 to be as automatically executable data, for example, an automatically executable CD. Furthermore, the data-storing block 112 is adopted for storing data and files, and can be a FAT (file allocation table) format or a NTFS (NT file system) format. The memory 11 may be comprised of an EROM (electrically programmable read only memory), an EEROM (electrically erasable read only memory), an EPROM (erasable programmable read only memory), an EEPROM (electrically erasable programmable read only memory), a FLASH (flash memory), an AND-flash memory, an OR-flash memory, a NAND flash memory or a HDD (hard disk drive).

The memory 11 is electrically connected to the microcontroller 12, and the microcontroller 12 is electrically connected to the triggering device 13. When operating the triggering device 13, different signal types are generated according to the triggering time period and the frequency and transmitted to the microcontroller 12. Furthermore, the triggering device 13 may be comprised of a key switch, a micro-switch, a connective proximity switch, a touch switch, a voltage switch, a capacitor switch or mechanical switch. It should be noted that the above mentioned examples are merely used to illustrate the triggering device 13 of the present invention and is not intended to limit the scope of the present invention, therefore other equivalent switch may also be used for generating signals according to, for example, time or frequency of each triggering, and microcontroller 12 for transmitting the signal in various formats/specifications shall also be considered within the scope of the present invention.

Furthermore, the microcontroller 12 transmits data to a host end 2 via the transmission interface 14. The transmission interface 14 may be wired or wireless type. The wireless signal transmission can be the Infrared, ZigBee, WiFi or the Bluetooth. The wired connection can be in the specification of IEEE1394 (Institute of Electrical and Electronic Engineers Standard Bus Interface), USB (Universal Serial Bus), SATA (Serial Advanced Technology Attachment), IDE (Integrated Device Electronics) or SCSI (Small Computer Standard Interface).

It should be noted that the wired or wireless transmission interface 14 in the above embodiment of the present invention is used as an example and is not intended to limit the scope of the present invention, therefore any equivalent transmission interface 14 capable of transmitting the signal between the microcontroller 12 and the host end 2 shall be construed within the scope of the present invention.

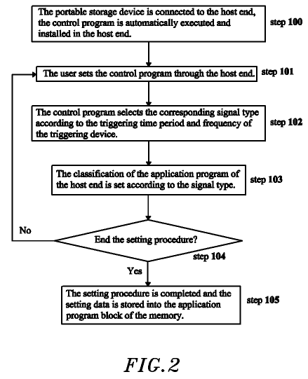

Referring to FIG. 2, a flowchart of setting the control program according to an embodiment of the present invention will be described with reference to FIG. 1 as follows.

At step 100, when the portable storage device 1 is electrically connected to the host end 2, the control program is automatically executed and installed in the host end 2.

At step 101, a user sets the control program through the host end 2.

At step 102, the control program selects a corresponding signal type according to the triggering time period and frequency of the triggering device 13.

At step 103, a classification of an application program of the host end 2 is set according to the corresponding signal type.

At step 104, whether or not to end the setting process is judged, if yes, the procedure proceeds to step 105; otherwise, the procedure returns back to step 101.

At step 105, the setting process is completed and a setting data is stored into the application program block 111 of the memory 11.

When executing the above steps, the host end 2 automatically runs the control program, and the control program is installed in the host end 2 to enable the user to set up the corresponding relationship between the signal type and the application program of the host end 2. For example, while changing the triggering time period and frequency of the triggering device 13, the control program will select a corresponding signal type to set up the classification of the application program of the host end 2, such as adding or reducing the classifications of the application program of the host end 2, and the setting data can be stored in the program block 111 of the memory 11.

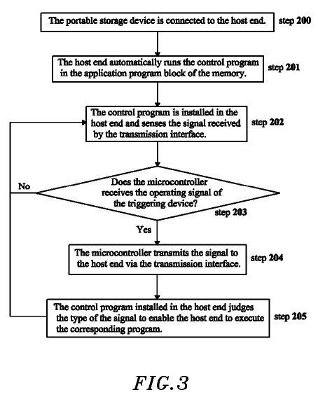

Referring to FIG. 3, when the portable storage device 1 is connected to the host end 2, an operation procedure will be described with reference to FIG. 1 as follows.

At step 200, the portable storage device 1 is connected to the host end 2.

At step 201, the host end 2 automatically runs the control program stored in the application program block 111 of the memory 11.

At step 202, the control program is installed in the host end 2 and senses a signal received by the transmission interface 14.

At step 203, whether or not the microcontroller 12 receiving an operating signal of the triggering device 13 is judged. If the microcontroller 12 receives the signal, the procedure proceeds to step 204; otherwise, the procedure returns to step 202.

At step 204, the microcontroller 12 transmits the signal to the host end 2 via the transmission interface 14.

At step 205, the control program installed in the host end 2 judges the type of the signal to enable the host end 2 to execute the corresponding application program, and then the procedure returns to step 202.

When executing the above steps, first of all, the portable storage device 1 is electrically connected the host end 2, and the host end 2 senses the memory 11 of the portable storage device 1 comprising the applying program block 111 which is automatically executable. For example, when the application program block 111 declares in an ISO9660 format, the host end 2 presumes the application program block 111 is in a CD format and automatically runs the control program stored in the application program block 111. The control program stored in the application program block 111 is thus executed automatically and installed in the host end 2. Meanwhile, the control program continuously senses whether any signals are being transmitted through the transmission interface 14.

After operating the triggering device 13 to generate and transmit a signal to the microcontroller 12, the microcontroller 12 transmits the signal to the host end 2 via the transmission interface 14. Next, the control program receives the signal and judges the type of the signal and accordingly enables the host end 2 to execute the corresponding application program. For example, when operating the triggering device 13 for a specific frequency or a specific time period to generate a signal, the signal is transmitted to the host end 2 through the microcontroller 12 and the transmission interface 14, and after the control program receives the signal, the host end 2 executes the application program according to the type of the signal.

Besides, the control program can judge the type of the signal, for instance, when operating the triggering device 13 for one time or one second, a specific file folder of the portable storage device 1 and the host end 2 will be refresh at the same time. Or when operating the triggering device 13 for three times or three seconds, the control program will retrieve an image of a display device (not shown) of the host end 2 and stores the image into the data-storing block 112 of the memory 11.

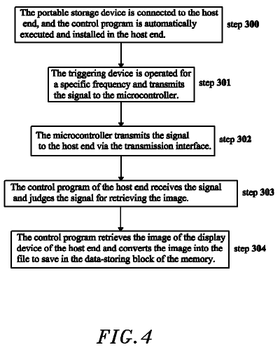

Referring to FIG. 4, a procedure of retrieving an image will be described with reference to FIG. 1 as follows.

At step 300, when the portable storage device 1 is electrically connected to the host end 2, the control program is automatically executed and installed in the host end 2.

At step 301, the triggering device 13 is operated for a specific frequency and transmits a signal to the microcontroller 12.

At step 302, the microcontroller 12 transmits the signal to the host end 2 via the transmission interface 14.

At step 303, the control program of the host end 2 receives the signal and judges the signal for retrieving an image.

At step 304, the control program retrieves the image of the display device (not shown) of the host end 2 and converts the image into a file to save in the data-storing block 112 of the memory 11.

Accordingly, the portable storage device of the present invention has the following advantages.

1. The portable storage device 1 can active and control the host end 2 to execute the application program, renewing the files and the data folders and retrieving the images.

2. When the portable storage device 1 is electrically connected to the host end 2, the user operates the triggering device 13 to generate and transmit the signal to the control program installed in the host end 2. Thus, no additional device is required for controlling the host end 2.

3. By operating the triggering device 13 to generate the signal, the control program of the host end 2 can control the host end 2, so that the flowchart can be simplification. At the same time, the classifications of the application program corresponding to the control program can be set by the user to upgrade the alteration and expansion.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What is claimed is:

1. A portable storage device with auto-executable program, comprising:
a microcontroller;
a transmission interface, electrically connected between a host end and said microcontroller for transmitting data;
a triggering device, electrically connected to said microcontroller; and
a memory, electrically connected to said microcontroller, comprising a data-storing block and an application program block, wherein said application program block comprises an auto-executable control program, wherein when said portable storage device is electrically connected to said host end, said control program stored in said application program block of said memory is automatically executed and installed in said host end, and said control program senses a signal generated by said triggering device and controls said host end to execute an application program according to a type of said signal.

2. The portable storage device with auto-executable program according to claim 1, wherein said memory comprises an EROM (electrically programmable read only memory), an EEROM (electrically erasable read only memory), an EPROM (erasable programmable read only memory), an EERPOM (electrically erasable programmable read only memory), a FLASH (flash memory), an AND-flash memory, a OR-flash memory, a NAND-flash memory or a HDD (hard disk drive).

3. The portable storage device with auto-executable program according to claim 1, wherein said application program block is in ISO9660 format.

4. The portable storage device with auto-executable program according to claim 1, wherein said data-storing block comprises a FAT (file allocation table) or a NTFS (NT file system).

5. The portable storage device with auto-executable program according to claim 1, wherein said transmission interface comprises a wired transmission interface or a wireless transmission interface.

6. The portable storage device with auto-executable program according to claim 5, wherein said wired transmission interface comprises an IEEE1394 (institute of electrical and electronic engineers standard bus interface), USB (universal serial bus), SATA (serial advanced technology attachment), IDE (integrated device electronics) or SCSI (small computer standard interface).

7. The portable storage device with auto-executable program according to claim 5, wherein said wireless transmission interface comprises Infrared, Bluetooth, ZigBee or WiFi.

8. The portable storage device with auto-executable program according to claim 1, wherein said triggering device comprises a key switch, a micro-switch, a connective proximity switch, a touch tone switch, a voltage switch, a capacitor switch or a mechanical switch.

9. The portable storage device with auto-executable program according to claim 1, wherein said triggering device generates various types of signal according to triggering time period or frequency.

10. The portable storage device with auto-executable program according to claim 1, wherein said control program enables a user to set up a corresponding relationship between said type of said signal and said application program of said host end.
